(19) United States
(12) Patent Application Publication
(10) Pub. No.: US 2011/0315476 A1
(43) Pub. Date: Dec. 29, 2011

(54) Ladder Stabilising Device

(76) Inventor: Ryan James Clarkson, New South Wales (AU)

(21) Appl. No.: 13/147,202

(22) PCT Filed: Jan. 29, 2010
(86) PCT No.: PCT/AU10/00089

§ 371 Date: Sep. 16, 2011

(30) Foreign Application Priority Data
Feb. 2, 2009 (AU) 2009900379

(51) Int. Cl. E06C 7/48

(52) U.S. Cl. 182/107

(57) ABSTRACT

A stabilising device for stabilising a ladder relative to a structure, the stabilising device comprising a main body having associated therewith a first mount which in use can be mounted to the ladder and a second mount which in use can be mounted to the structure wherein said main body comprises an elongated member said mountings being operatively secured thereto in spaced relation therealong.

This invention relates generally to a device for stabilising a ladder relative to a structure.

### BACKGROUND OF THE INVENTION

The dangers associated with ladders moving or falling when leaning against or otherwise positioned relative to a structure are well documented. There is a need for a device which can stabilise a ladder when in use thereby improving the safety for an operator.

### SUMMARY OF THE INVENTION

According to one aspect of the present invention there is provided a stabilising device for a ladder for stabilising the ladder relative to a structure, the stabilising device comprising a main body having associated therewith a first mount which in use can be mounted to the ladder and a second mount which in use can be mounted to the structure. The arrangement is such that in a fitted position relative movement between the ladder and the structure is inhibited in at least some directions.

In one form the main body comprises an elongated member the mounts being operatively secured thereto or integral therewith in spaced relation therealong. The mounts may for example be disposed in the region of opposite ends of the elongated member. The elongated member may be in the form of a bar or tube and may be formed from any suitable material such as metals such as aluminium, plastics or the like.

In one form the elongated member comprises at least two parts which can be adjustably positioned relative to one another so that the overall length of the elongated member can be adjusted. For example the two parts may have cooperating threaded portions which as a result of relative rotation therebetween causes adjustment of the overall length of the elongated member to be adjusted. To this end one part may have a swivel associated therewith and the other part a threaded section cooperating with a threaded section on the swivel. In another form one of the two parts may include a hollow portion for receiving at least a part of the other of the two parts therein in telescopic fashion and arranged so that they can be locked together at different positions.

The first and second mounts may in one form comprise brackets one being adapted to be fitted to the ladder and the other being adapted to be fitted to the structure. One bracket may comprise a ring shaped member which can be releasably fitted to a rung of the ladder. The other bracket may be in the form of a channel which can be fitted to a part of the structure.

The structure with which the device can be used may comprise a building having a roof. In one form the channel of the second mount may be adapted to be fitted to a rafter truss or other structural section of the roof. In the case of a tiled roof this may entail removing one or more of the roofing tiles so that the second mount can be fitted to the structural section.

In use when the two brackets are fitted to the ladder and structure the overall length of the main body can be adjusted so that it can adopt a tensioned condition.

The stabilising device may further include an anchor point on the main body to which a harness for use by personnel can be operatively mounted.

In one form the second mount may further include an adapter which can be mounted to roofing such as roof sheeting and to which the second bracket can be operatively connected. The adaptor may comprise a base part which can be supported on roof sheeting and a connector to which the other part of the second mount can be attached. The base part can be secured to the roof structure through the sheeting using existing holes for fasteners. The base part may have a profile which substantially conforms to that of the sheeting. For example the base part may have a generally sinusoidal profile to cooperate with corrugated roof sheeting. In another arrangement the profile may be flat for flat roof sheeting. The connector may comprise a bar mounted in spaced relation from the base part.

### BRIEF DESCRIPTION OF THE ACCOMPANYING FIGURES

The present invention will become better understood from the following detailed description of various non-limiting embodiments thereof, described in connection with the accompanying figures, wherein:

FIG. 1 is a schematic side elevation of a ladder positioned against a structure with a stabilising device according to one form of the invention in a fitted position;

FIG. 2 is a side elevation of a device according to one form of the invention;

FIG. 3 is a side elevation of a part of a stabilising device according to one part of the invention;

FIG. 4 is a side elevation of a similar part to that shown in FIG. 3 of a device according to another form of the invention;

FIG. 5 is a plan view of roof sheeting with the part shown in FIG. 3 in position thereon;

FIG. 6 is a perspective view from above, the front and one side of a stabilising device according to one form of the invention;

FIG. 7 is perspective view from above, the front and one side of a stabilising device according to another form of the invention;

FIG. 8 is a perspective view from above, the front and one side of a stabilising device according to a further form of the invention; and,

FIG. 9 is a perspective view from above, the front and one side of a stabilising device according to yet another form of the invention.

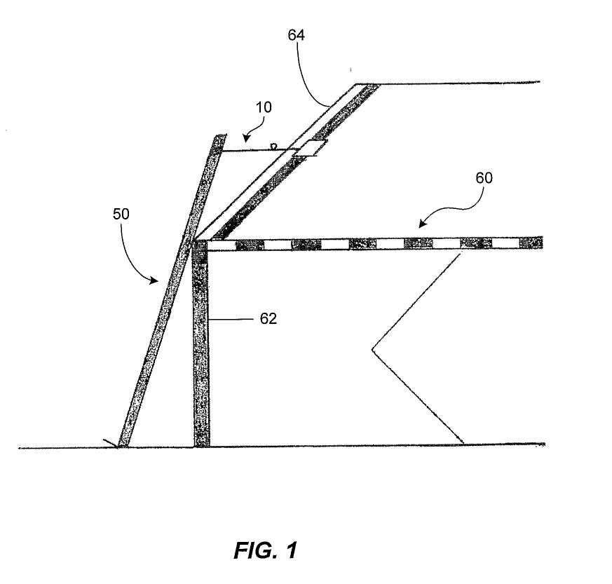

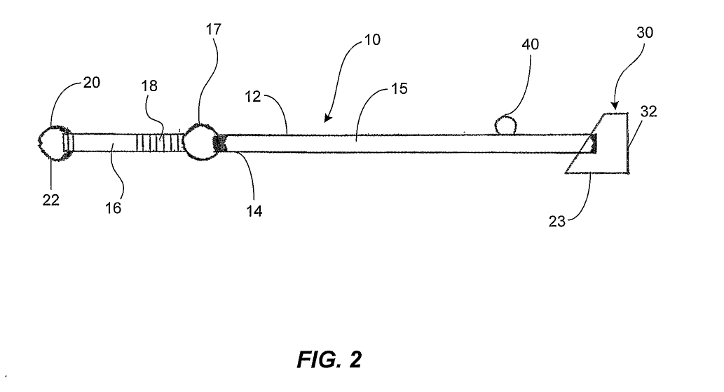

### DETAILED DESCRIPTION OF EMBODIMENTS OF THE INVENTION AND THE ACCOMPANYING FIGURES

Referring to the figures there is shown a stabilising device 10 for a ladder 50 for stabilising the ladder relative to a structure 60. The stabilising device 10 comprises a main body 12 having associated therewith a first mount 20 which in use can be mounted to the ladder and a second mount 30 which in use can be mounted to the structure. The main body 12 comprises an elongated member 14 the mounts being operatively secured thereto in spaced relation therealong in the region of opposite ends thereof. The elongated member 14 comprises two parts 15 and 16 which can be adjustably positioned relative to one another so that the overall length of the elongated member can be adjusted. The elongated member includes a swivel 17 which cooperates with a threaded section 18 on part 16 so that rotation of the swivel changes the overall length of the body.

The first and second mounts 20 and 30 are in the form of brackets 22 and 23 one being adapted to be fitted to the ladder and the other being adapted to be fitted to the structure. The first bracket 22 comprises a ring shaped member which can be releasably fitted to a rung of the ladder. The second bracket 23 is in the form of a channel 32 which can be fitted to a part of the structure. The structure 60 comprises a building 62 having a roof 64, the channel 32 being adapted to be fitted to a rafter or truss of the roof.

The stabilising device further includes an anchor point 40 on the main body to which a harness can be operatively mounted such that personnel wearing the harness may be safely tethered to the stabilising device and therefore the structure when working on the roof section of the structure typically at dangerous heights above ground level.

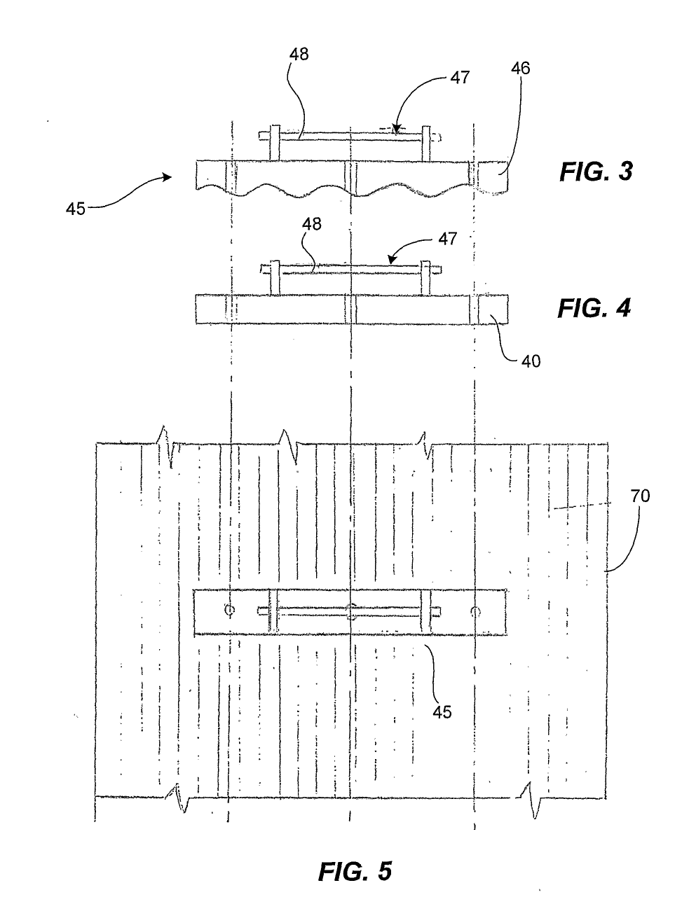

As shown in FIGS. 3 to 5, the second mount 30 may in some applications further include an adapter 45 which can be mounted to roofing and to which the channel 32 can be operatively connected. The adaptor 45 comprises a base part 46 which can be supported on roof sheeting 70 and a connector 47 to which the bracket 32 can be attached. The base part has a profile which substantially conforms to that of the sheeting. In the embodiment of FIG. 3 the profile conforms to that of corrugated sheeting and in the embodiment of FIG. 4 the profile is generally flat. The connector comprises a bar 48 mounted in spaced relation from the base part.

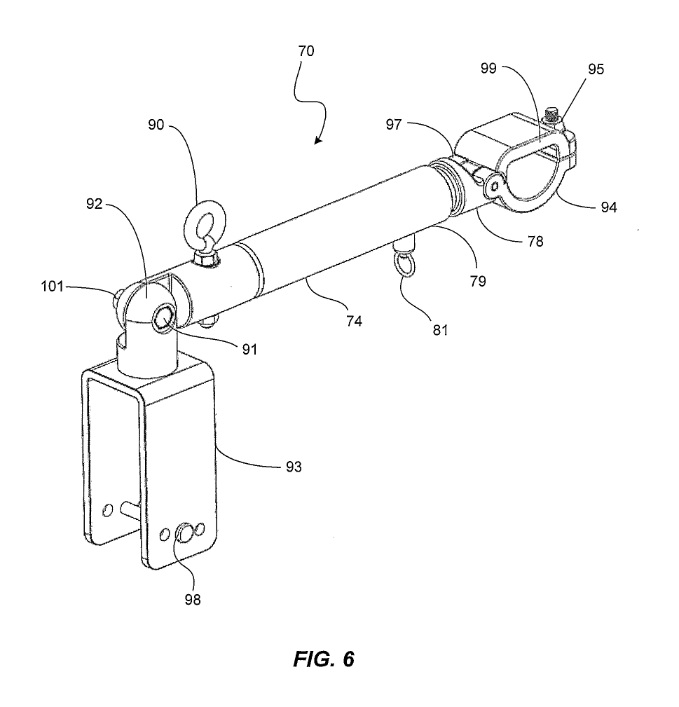

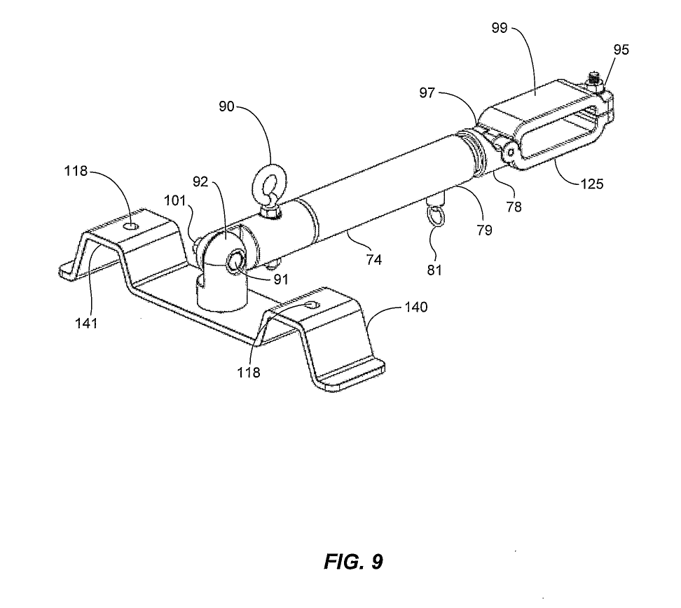

FIGS. 6 to 9 depict further alternative forms of a stabilising device 50 in accordance with further embodiments of the present invention. The stabilising device 50 includes an elongated member comprised of two parts 78, 79 wherein one part 79 includes a hollow portion for receiving at least a part of the other of the two parts 78 therein in telescopic fashion and arranged so that the two parts 78, 79 can be locked relative to each other at different positions by a locking pin 81 thereby adjusting the overall length of the elongated member 74. The locking pin 81 is able to cooperate with corresponding holes (not shown) located on the cooperating portions of the two parts 78, 79. In the present embodiment part 79 includes one hole and the part of the other part 78 that is received within the hollow portion of the part 79 includes a plurality holes that may each align with the one hole of the part 79 to provide the different length adjustments for the elongated member 74. The locking pin 81 is biased in place in a locking position by a spring (also not shown).

At one end of the elongated member 74 there is a first mount 94 that is adapted to releasably attach to a rung of a ladder. The mount 94 comprises a ring like clamp that includes a top half 99 that may be pivoted at pivot point 97 and opened to receive the rung of a ladder. A bolt and nut arrangement 95 is included to fasten the top half in position when the ladder rung has been received within the mount 94.

At the other end of the elongated member 74 there is a second mount 92 that is adapted to mount to a structure which in this case may be a rafter, truss, or other structural section of a roof. The second mount 92 is attached to the elongated member 74 whereby the mount 92 is able to pivot relative to the elongated member 74 around a pivot point 91. The ability to rotate around the pivot point 91 provides that the mount 92 may be secured to a structural section of the roof that may be at an angle to the elongated member 74. Once attached to a structural section of the roof, the mount 92 may be fixed relative to the elongated member 74 by securing and tightening bolt 101 to ensure the stabilising device 70 is tensioned and sufficiently rigid to hold the ladder in alignment with the roof structure.

The second mount 92 in the embodiment shown in FIG. 6 includes a u shaped element 93 that may receive the structural section of roof structure such as a truss or rafter within the U region. The securing bolt 98 may then be inserted which holds the structural section of the roof structure within the U region of the u shaped element 93.

An anchor point 90 is also provided to which a harness for use by personal can be operatively mounted.

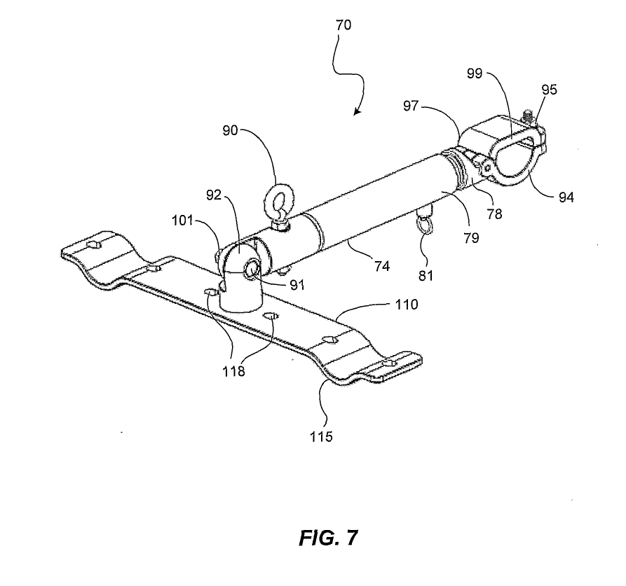

Referring now specifically to the various embodiments depicted in FIGS. 7, 8 and 9 each of these figures illustrates a stabilising device 70 which includes various different mounts for attaching to either a ladder, step ladder, or various types of roof structures. FIG. 7 illustrates the same first mount 94 as illustrated in FIG. 6, although the second mount 92 includes a planar portion 110 that is adapted to cooperate with a corrugated roof structure. The planar portion 110 includes concave elements 115 which cooperate with the convex portions of a corrugated roof structure such as a corrugated iron roof. In addition, holes 118 appearing along the planar portion 110 are adapted to receive bolts already present in the corrugated roof structure such that the stabilising device 70 can make use or existing attachment elements on the roof structure to retain itself against the roof structure.

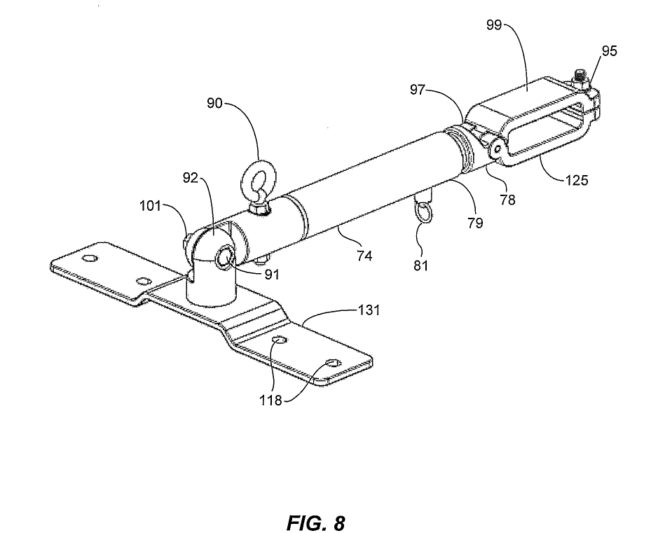

FIG. 8 includes an alternative first mount 125 which is in the form of an elongate ring 125 and adapted to receive the step portion of a step ladder rather than a rung of a ladder. In addition, the second mount 92 includes a planar portion 131 adapted to cooperate with flat sheet roofing of a roof structure which further includes holes 118 to receive bolts already present in the flat sheeting roof structure.

FIG. 7 provides a further embodiment with a first mount 125 adapted to receive the step portion of a step ladder as illustrated in FIG. 8 and the second mount 92 including a attachment portion 140 that has shaped elements 141 to cooperate with an alternative styled roof sheeting structure.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Finally, it is to be understood that various alterations, modifications and/or additions may be incorporated into the various constructions and arrangements of parts without departing from the spirit or ambit of the invention.

1. A stabilising device for stabilising a ladder relative to a structure, the stabilising device comprising a main body having associated therewith a first mount which in use can be mounted to the ladder and a second mount which in use can be mounted to the structure wherein said main body comprises an elongated member said mountings being operatively secured thereto in spaced relation therealong.

2. A stabilising device according to claim 2 wherein said mountings are disposed in the region of opposite ends of the elongated member.

3. A stabilising device according to claim 2 or claim 3 wherein said elongated member comprises at least two parts which can be adjustably positioned relative to one another so that the overall length of the elongated member can be adjusted.

4. A stabilising device according to claim 3 wherein the two parts include cooperating threaded portions whereby relative rotation therebetween causes the overall length of the elongated member to be adjusted.

5. A stabilising device according to claim 4 wherein one part includes a swivel associated therewith and the other part a threaded section cooperating with a threaded section on the swivel.

6. A stabilising device according to claim 3 wherein one of the two parts includes a hollow portion for receiving at least a part of the other of the two parts therein in telescopic fashion and arranged so that the two parts can be locked relative to each other at different positions.

7. A stabilising device according to any one of claims 1 to 6 wherein the first and second mounts comprise brackets.

8. A stabilising device according to claim 7 wherein the bracket of the first mount is adapted to be fitted to the ladder.

9. A stabilising device according to claim 8 wherein the bracket of the first mount comprises a ring shaped member which can be releasably fitted to a rung of the ladder.

10. A stabilising device according to claim 8 wherein the bracket of the first mount comprises an elongated ring shaped member which can be releasably fitted to a step in a step ladder.

11. A stabilising device according to claim 7 wherein the bracket of the second mount is in the form of a channel which can be fitted to a part of the structure.

12. A stabilising device according to claim 11 wherein the bracket of the second mount is adapted to be fitted to a rafter, truss or other structural section of a roof.

13. A stabilising device according to claim 11 wherein the bracket of the second mount is adapted be mounted to roofing such as roof sheeting.

14. A stabilising device according to claim 13 wherein the bracket of the second mount can be secured to the roof structure through the roof sheeting using existing holes for fasteners.

15. A stabilising device wherein the bracket of the second mount has a profile that substantially conforms to that of the roof sheeting.

16. A stabilising device according to claim 15 wherein the bracket of the second mount has a sinusoidal profile to cooperate with roof sheeting that is the form of corrugated roof sheeting.

17. A stabilising device according to claim 15 wherein the bracket of the second mount has a substantially flat profile to cooperate with roof sheeting that is in the form of flat roof sheeting.

18. A stabilising device according to any one of claims 7 to 17 whereby in use when the two brackets are fitted to the ladder and structure the overall length of the main body can be adjusted so that it can adopt a tensioned condition.

19. A stabilising device according to any one of claims 1 to 18 further including an anchor point on the main body to which a harness for use by personnel can be operatively mounted.
